(19) United States
(12) Patent Application Publication
(10) Pub. No.: US 2007/0182530 A1
(43) Pub. Date: Aug. 9, 2007

(54) Power and data transmission device

(76) Inventors: Ekkehard Pilz, Grossschonau (DE); Bernd Gasse, Markersdorf (DE)

Correspondence Address: WILLIAM COLLARD;COLLARD & ROE, P.C., 1077 NORTHERN BOULEVARD, ROSLYN, NY, 11576, US

(21) Appl. No.: 10/591,106

(22) PCT Filed: Feb. 28, 2005
(86) PCT No.: PCT/EP05/50837

§ 371 Date: Aug. 30, 2006

(30) Foreign Application Priority Data
Mar. 1, 2004 (DE) 10 2004 010 427.1
Jul. 12, 2004 (DE) 10 2004 035 415.4

(51) Int. Cl. B60C 23/00

(52) U.S. Cl. 340/438; 152/152.1

(57) ABSTRACT

A wheel housing unit is connected to a vehicle processing unit for each travelling wheel, which unit comprises a current supply unit connected to an on-board mains, an interface unit connected to a bus system, a control unit, a storage unit, an HF signal generator, a modulator/demodulator, an amplifier unit and at least one antenna, a transponder component is arranged in or on each tyre, which component comprises a circuit board with an electronic circuit, which incorporates at least one pressure and/or temperature sensor, an HF transponder circuit with receiving, transmitting and signal processing components and a rectifier and smoothing circuit, a coupling coil connecting the input terminals of the electronic circuit and surrounding an I-core, and a U-core magnetically coupled to the I-core, and is provided with an envelope provided with an air inlet and connected to the tyre, and where each tyre has a ring conductor which is arranged coaxially, penetrates the U-core and is thereby inductively coupled to it, and consists of flexible material (FIG. 2).

### POWER AND DATA TRANSMISSION DEVICE

The invention relates to a device for the wireless power supply, preferably to sensors arranged in vehicle tyres, and for data transmission between the sensors by means of electronic functional units required for their operation such as signal processing devices and transmission and receiving devices on one side, and remote terminals secured to the vehicle.

Devices for wireless power transmission are of prior art. DE 101 64 488 discloses a device for the transmission and/or receiving of data, tyres for a motor vehicle, transmission and/or receiving device and system for wireless transmission of data, provision being made for power to be supplied to the device located in a rotary part and for data to be transmitted in any position of the moving part. The device is arranged in spatial vicinity to a metal belt of a moving part, in particular a motor vehicle tyre. A transmitting and receiving device and a control device connected to it are also arranged on the vehicle. The device arranged in the tyre incorporates not only a transmitting and/or receiving unit an antenna device and a power accumulator, as well as a data processing device and sensorics, which of which are electrically connected according to their respective tasks. The data obtained by means of the sensorics and processed accordingly are transmitted wirelessly by the transmitting and/or receiving unit and the antenna device to the remote terminal arranged on the vehicle. The power required for this is obtained from the radio field for transmitting the data between the transmitting/receiving units in the tyre and on the vehicle using the metal belt of the tyre. Here it may be a problem for the tyre belt to be designed as a steel belt because steel belts screen the radio waves used for the data transmission and the efficiency of the power supply is thereby reduced. Counteracting this is the solution of prior art transmission power of the radio field is chosen so low that the screening of the metal belt based on the induction of eddy currents with the vectors of the magnetic field strength of the radio field is kept as low as possible and in that the magnetic field generated by the radio field penetrates the metal belt. Because of the bending of the magnetic field around the metal belt due to the electrical conductivity of the metal belt, the power from the radio wave field is distributed around the entire periphery of the tyre belt. Power is derived from this radio wave belt thus bent by the antenna device because the antenna device is arranged in the immediate spatial vicinity of the tyre belt and is in this manner connected to the tyre belt capacitively and/or inductively. The power absorbed by the antenna device is supplied to a power accumulator which is designed as a capacitor device. However, the possibility is not ruled out that a standing wave of the radio field is generated on the tyre belt, which wave would prevent the receiving of radio waves by the device arranged in the tyre in the zero point ranges. The transmitting and receiving device and the control device on the vehicle are therefore designed for establishing a standing wave of the radio field formed on the tyre belt. To avoid this phenomenon the frequency of the radio field is set differently from the resonance frequency of the tyre, the resonance conditions being obtained from the tyre data which are known to the control device on the vehicle. Instead of the tyre belt an additional antenna, particularly in the form of a wire, may be used as the field antenna which is arranged in the inner tread of the tyre. Here the wire can be mounted both in front of and behind the tyre belt, and can, in particular, be made available through the method of construction of the tyre. The additional antenna derives power from the radio field and feeds it to the antenna device, thereby reducing the influence of the rim on the electromagnetic field, and addition to providing a speed-dependent mode of operation, improved power input and interference-free reception are achieved. In view of the requirement that a near field situation must be controlled, limits are predetermined in terms of both frequency and, in particular, transmission power. However, if the transmission power is low because of the exclusion of the mutual interferences of the individual devices of a vehicle and other systems, the transmissible power is also necessarily low and, in particular, is not suitable for use as supply power, in the form of an operating voltage for the power consuming components of the device arranged in the tyre, without additional measures such as accumulation, i.e. a continuous build-up of charge over time.

The object of the invention is therefore to simplify the wireless transmission of electricity to generate voltage for supplying an electrical consumer arranged, if necessary, in or on a rotary device, and to reduce the required expenditure and to link it to the data transmission.

The object of the invention is achieved according to the theory of the main claim in that a first coil connected to a supply device forms the primary winding and a ring conductor forms the secondary winding of a transformer and a second coil is coupled inductively to the ring conductor to which an electrical consumer is connected.

As far as the preferred application is concerned, the invention is developed and advantageously equipped by the characteristics of the dependent claims. Such a development of the invention, in terms of its functionality, consists in that the supply device comprises a supply, receiving and transmitting unit and/or the electrical consumer is designed as an electronic circuit. The invention is advantageously equipped in that the electronic circuit comprises a storage unit, at least one sensor element and a rectifier and smoothing circuit, and in that the rectifier and smoothing circuit is connected to the second coil, and in particular in that the transmitting unit is designed as a load modulator. With regard to the use of the invention in the field of the transmission of wheel and tyre parameters and the measured data on the vehicle recorded in or on the tyre, particularly during operation, it is advantageous for the ring conductor to consist of a flexible material, for the second coil and the electrical consumer to be arranged coaxially on or in a tyre, and for the supply device and the first coil to be arranged stationarily. In order to ensure the intended high conductivity of the ring conductor it is advantageous for the diameter of the ring conductor to be greater or smaller than the diameter of the metal belt of the tyre, and for the supply unit to be arranged with the first coil in the wheel housing area of a motor vehicle. Here it is irrelevant whether the ring conductor is arranged exclusively outside, exclusively inside or penetrating the metal belt, and hence partially outside and partially inside the metal belt of the tyre.

The device according is further characterised in that a wheel housing unit is connected to the vehicle processing unit for each travelling wheel, which wheel housing unit comprises a current supply unit connected to the on-board mains, an interface unit connected to a bus system, a control unit, a storage unit, an HF signal generator, a modulator/demodulator, an amplifier unit and at least one antenna, a transponder component is arranged in or on each tyre, which component comprises a circuit board with an electronic circuit, which incorporates at least one pressure and/or temperature sensor, an HF transponder circuit with receiving, transmitting and signal processing components and a rectifier and smoothing circuit, a coupling coil connecting the input terminals of the electrical circuit and encircling an I-core, and a U-core magnetically coupled to the U-core, and is surrounded by an envelope provided with an air inlet and connected to the tyre, and in that each tyre has a coaxially arranged ring conductor penetrating the U-core and thereby connected inductively to it, the ring conductor consisting of a flexible material and the diameter of the ring conductor being greater than or smaller than the diameter of the metal belt of the tyre. The method used for the power and data transmission is characterised in that the HF carrier signal is transmitted via the transmitting antenna of the wheel housing unit, the magnetic alternating field generated thereby induces an alternating current flowing in the ring conductor, this alternating current generates a magnetic flux in the U-core crossing the ring conductor and in the connected I-core, and in that the magnetic flux in the coupling coil induces an alternating current voltage which is converted by means of the rectifier and smoothing circuit to at least one operating direct current voltage, and data transmission takes place from the transponder component to the wheel housing unit when the HF carrier signal is transmitted via the transmitting antenna of the wheel housing unit, the HF carrier signal is fed parallel with the rectifier and smoothing circuit to a frequency divider and an auxiliary carrier signal is thereby generated, the auxiliary carrier signal is modulated with low frequency data signals obtained by means of the sensor and processed by means of the signal processing unit, a switch is controlled y means of the modulated auxiliary carrier signal, which switch loads the transponder winding with a resistance so that side band frequency signals modulated with the data signal are generated whose frequencies have distances of whole number multiples of the frequency of the auxiliary carrier signal from the frequency of the HF carrier signal, the signal mixture is transmitted by the transponder and is received via the receiving antenna from the wheel housing unit in which the modulated auxiliary carrier signals are separated by partial suppression of the carrier signals, amplification and mixing on a non-linear characteristic, each signal is filtered with the auxiliary carrier frequency originally obtained from the HF carrier signal by frequency division from the multiplicity of the modulated auxiliary carrier signals and is demodulated so that the data signals are processed and transmitted via the interface to the bus system.

The invention is advantageously equipped in that the wheel housing unit has a first antenna acting as a receiving antenna for modulated data signals and a second antenna acting as a transmitting antenna for an HF carrier signal, wherein the first antenna is arranged in the wheel housing so that it is located in a first region of minimum field strength of the second antenna, and so that the second antenna is connected to the wheel housing unit by means of a supply cable in the form of a twisted cable or a double cable. This type of connection minimises interfering influences. An embodiment of the invention consists in that the tyre transponder component has a signal processing unit and bidirectional data transmission takes place between the radial housing unit and the tyre transponder component.

The device according to the invention is characterised by a mode of operation that is independent of the speed of rotation in terms of both its value and its direction. Nevertheless the best results are achieved if the antennae of the wheel housing unit are arranged in the plane of straight rotation of the travelling wheel. It is self-evident, however, that the transponder component or the ring conductor is advantageously arranged in the line of symmetry of the tyre in order to guarantee constant transmission properties both in right-hand and left-hand assembly.

The invention is explained in greater detail in the form of a preferred exemplary embodiment with reference to the drawing, in which:

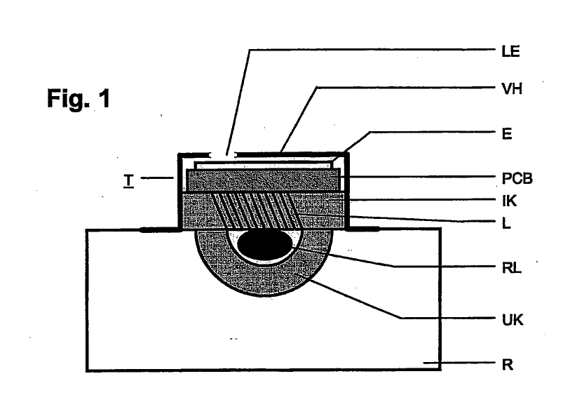

FIG. 1 shows a transponder component in the longitudinal section

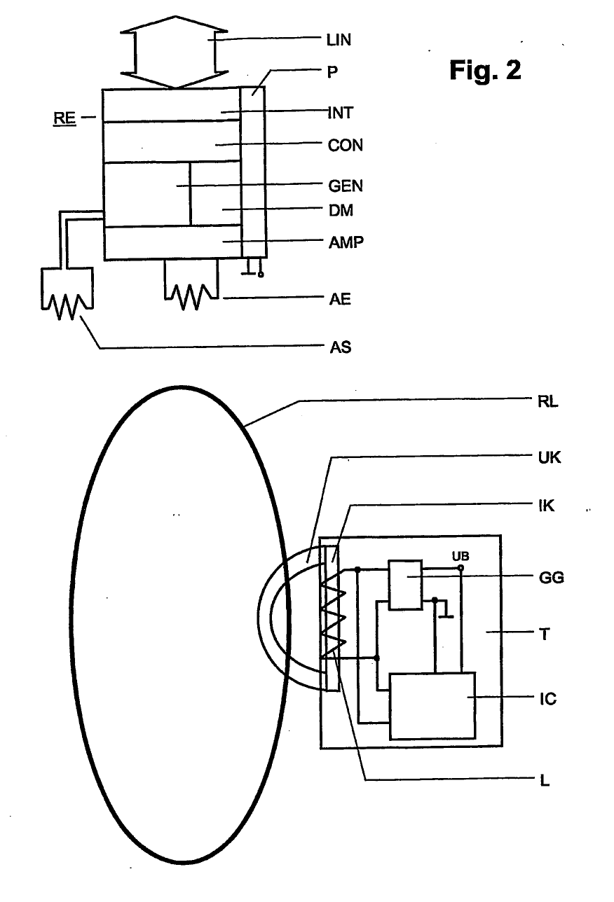

FIG. 2 shows an electrical working diagram.

FIG. 1 shows the structure of a transponder component according to the invention. The component contains an electronic circuit E, which is installed on a printed circuit board PCB and consists of a pressure and temperature sensor, an HF transponder circuit with receiving, transmitting and signal processing components and a rectifier and smoothing circuit. The printed circuit board PCB is arranged on an I-core IK, which carries a coil L. Coil L serves for connection and disconnection during the data transmission between the transponder and the wheel housing unit and as a coupling inductance for the power transmission to the transponder, and is connected to the electronic circuit E. The transponder component is surrounded by an envelope VH, which is vulcanised on the inside of tyre R. Envelope VH is provided with an air inlet LE, through which the pressure and temperature sensor of the transponder component is subjected to the inner tyre air. If only a pressure measurement is to be carried out, a membrane region can be provided instead of air inlet LE. A ring conductor RL, consisting of a flexible conductive material, e.g. copper braid, which acts on the one hand as an antenna for the data transmission and as a rotary secondary coil of the transformer formed for the power supply, is embedded coaxially in tyre R. The ring conductor penetrates a U-core UK, which is magnetically coupled to the I-core IK.

The mode of operation of the device according to the invention is explained with reference to FIG. 2. Connected to the on-board mains is a wheel housing unit RE which comprises a power supply unit P, an interface unit INT connected to a bus system LIN, a control and storage unit CON, an HF signal generator GEN, a modulator/demodulator DM and an amplifier unit AMP. A receiving antenna AE is connected to amplifier unit AMP, and a transmitting antenna AS is connected by a double cable with conductors assembled close together is connected to the HF signal generator. Receiving antenna AE is arranged in the wheel housing so that it is located in a region of minimum field strength of transmitting antenna AS. It is also advantageous for both antennae to be arranged in the principal plane of rotation of tyre R. Nevertheless it is insignificant for the mode of operation that the principal plane of rotation is frequently departed from by the steering lock, particularly in the case of the front wheels. The HF carrier signal is transmitted by wheel housing unit RE via transmitting antenna AS. With regard to the power feed to transponder component T, the magnetic alternating field thus generated induces an alternating current flowing in ring conductor RL, which current generates a magnetic flux in the U-core UK crossing ring conductor RL and the coupled I-core IK. The magnetic flux induces in coupling coil L an alternating current voltage which is converted by means of a rectifier and smoothing circuit GG to at least one operating a.c. voltage UB. The data transmission from transponder component T to wheel housing unit RE takes place when the HF carrier signal is transmitted via transmitting antenna AS of wheel housing unit RE and is fed parallel with the rectifier and smoothing circuit GG to a frequency divider, which is a component of electronic circuit C and, in particular, of a receiving, transmitting and signal processing component IC shown briefly here, and when an auxiliary carrier signal is generated so that the auxiliary carrier signal is modulated with low frequency data signals obtained by means of the sensor and processed by means of the signal processing unit, a switch is controlled by means of the modulated auxiliary carrier signal, which switch the loads the transponder winding with a resistance so that side band frequency signals modulated with the data signal are generated, the frequencies of which signals have distances of whole number multiples of the frequency of the auxiliary carrier signal from the frequency of the HF carrier signal, the signal mixture is transmitted by transponder T and is received via receiving antenna AE from wheel housing unit RE. In wheel housing unit RE the modulated auxiliary carrier signals are separated by partial suppression of the carrier signal, amplification and mixing on a non-linear characteristic. The auxiliary carrier signal, with the auxiliary carrier frequency originally obtained from the HF carrier signal by frequency division, is filtered out from the multiplicity of the modulated auxiliary carrier signals, and demodulated. The data signals are then processed and transmitted via the interface to the bus system so that an indication on a cockpit display is possible, for example.

1. A device for the wireless transmission of electricity for the generation of at least one supply voltage for one or more electrical consumers which, if necessary, is/are arranged on a rotary device (1), wherein a first coil (4) connected to a supply device (15) forms the primary winding and a ring conductor (2) forms the secondary winding of a transformer, and a second coil (6) is inductively coupled to the ring conductor (2) to which coil an electrical consumer (A) is connected.

2. The device according to claim 1, wherein the supply deice (15) comprises a supply, receiving and a transmitting unit designed as a load modulator, in that the electrical consumer (A) is designed as an electronic circuit which comprises a transmitting unit (13), a processing and control unit (11), a storage unit (12), at least one sensor element (10) and a rectifier and smoothing circuit (8), in that the rectifier and smoothing circuit (8) is connected to the second coil (6), and in that the ring conductor (2) consisting of a flexible material is arranged coaxially and the second coil (6) and the electrical consumers (A) are arranged on or in a rotary device (1) and the supply device (15) and the first coil (4) are arranged stationarily.

3. The device according to claim 2, wherein the rotary device (1) is a motor vehicle tyre, wherein the diameter of the ring conductor (2) is greater or smaller than the diameter of the metal belt (3) of the tyre (1), and in that the supply device (15) is arranged with the first coil (4) in the wheel housing region (31) of a motor vehicle (100).

4. The device according to claim 2 for supplying voltage to a transponder (T) arranged in or on a vehicle tyre (R), and for the data transmission between the transponder (1) and a vehicle processing unit, wherein
a wheel housing unit (RE) is connected to the vehicle processing unit for each travelling wheel, which wheel housing unit comprises an interface unit (INT) connected to a bus system (LIN), a control unit (CON), a storage unit, an HF signal generator (GEN), a modulator/demodulator (AE, AS),
a transponder component (T) is arranged in or on each tyre, which component comprises a circuit board (PCB) with an electronic circuit (E), which incorporates a pressure and/or temperature sensor, an HF transponder circuit with receiving, transmitting and signal processing components (IC) and a rectifier and smoothing circuit (GG), a coupling coil (L) connecting the input terminals of the electronic circuit (E) and surrounding an I-core (IK), and a U-core (UK) magnetically coupled to the I-core (IK), and is surrounded by a envelope (VH) provided with an air inlet (LE) and connected to the tyre (R), and
each tyre (R)has a ring conductor (RL) arranged coaxially, penetrating the U-core (UK) and hence coupled inductively to it, and consisting of flexible material, the diameter of which ring conductor is greater or smaller than the diameter of the metal belt of the tyre (R).

5. The device according to claim 4, wherein the wheel housing unit (RE) is provided with a first antennae (AE) acting as a receiving antenna for modulated data signals, and a second antenna (AS) acting as a transmitting antenna for an HF carrier signal, wherein the first antenna (AE) is arranged in the wheel housing so that it is located in a region of minimum field strength of the second antenna (AS), and the second antenna (AS) is connected to the wheel housing unit (RE) by means of a twisted or double cable with conductors assembled close together.

6. The device according to claim 4, wherein the power supply is fed to the transponder component (T) when
the HF carrier signal is transmitted via the transmitting antenna (AS) of the wheel housing unit (RE),
the magnetic alternating field thus generated induces an alternating current flowing in the ring conductor (RL),
this alternating current generates a magnetic flux in the U-core (K) crossing the ring conductor (RL) and in the connected I-core (IK), and
the magnetic flux in the coupling coil (L) induces an alternating current voltage which is converted by means of the rectifier and smoothing circuit (GG) to at least one operating d.c. voltage (UB), and
the data transmission from the transponder component (T) to the wheel housing unit (RE) takes place when
the HF carrier signal is transmitted via the transmitting antenna (AS) of the wheel housing unit (RE),
the HF carrier signal is transmitted to a frequency divider parallel with the rectifier and smoothing circuit (GG), thereby generating an auxiliary carrier signal,
the auxiliary carrier signal is modulated with low frequency data signals obtained by means of the sensor and processed by means of the signal processing unit,
a switch is controlled by means of the modulated auxiliary carrier signal, which switch loads the transponder winding with a resistance so that side band frequency signals modulated with the data signal are generated, the frequencies of which signals have distances of whole number multiples of the frequency of the auxiliary carrier signals from the HF carrier signal,
the signal mixture is transmitted by the transponder (T) and is received via the receiving antenna (AE) from the wheel housing unit (RE) in which the modulated auxiliary carrier signals are separated by partial suppression of the carrier signal, amplification and mixing on a non-linear characteristic,
each signal, from the multiplicity of the modulated auxiliary signals, is filtered out and demodulated with the auxiliary carrier frequency originally obtained from the HF carrier signal by frequency division so that the data signals are processed and transmitted via the interface (INT) to the bus system (LIN).

7. The device according to claim 4, wherein the tyre transponder component (T) has a signal processing unit and in that bidirectional data transmission takes place between the wheel housing unit (RE) and tyre transponder component (T).
